(19) United States
(12) Patent Application Publication
(10) Pub. No.: US 2015/0281850 A1
(43) Pub. Date: Oct. 1, 2015

(54) HYBRID ELECTROSTATIC HEADPHONE MODULE

(71) Applicants: Tien-Lai Wang, NEW TAIPEI CITY (TW); Ming-Hua Chang, NEW TAIPEI CITY (TW)

(72) Inventors: Tien-Lai Wang, NEW TAIPEI CITY (TW); Ming-Hua Chang, NEW TAIPEI CITY (TW)

(73) Assignee: VERISONIX CORPORATION, NEW TAIPEI CITY (TW)

(21) Appl. No.: 14/461,409

(22) Filed: Aug. 17, 2014

(30) Foreign Application Priority Data
Mar. 28, 2014 (TW) 103205424

(51) Int. Cl. H04R 23/02; H04R 1/26; H04R 1/24; H04R 19/01; H04R 9/06

(52) U.S. Cl. CPC H04R 23/02; H04R 19/013; H04R 9/06; H04R 1/24; H04R 1/26

(57) ABSTRACT

The present invention discloses a hybrid electrostatic headphone module, with the hybrid electrostatic headphone module disposed in the interior of a left and a right ear cup of a stereo headphones. The hybrid electrostatic headphone module is assembled as a single unit from a traditional moving coil type headphone unit and an electret headphone unit (E-STAT), which are respectively responsible for medium-low frequency bands and medium-high frequency bands. A frequency divider assembled from a frequency division capacitance and a drive transformer divides a complete signal into medium-high frequency and medium-low frequency bands, which are then respectively supplied to high and low frequency sound speakers for output therefrom.

### BACKGROUND OF THE INVENTION

(a) Field of the Invention

The present invention relates to a hybrid electrostatic headphone module, and more particularly to: an hybrid electrostatic headphone module that adopts a dual sound channel to achieve a frequency division effect through an internal frequency divider, thereby retaining reproduction of the original sound of the music in stereo headphones, and providing the headphones with more outstanding audio frequency resolution.

(b) Description of the Prior Art

The ear cups of general dual earset stereo headphones, suitable for music appreciation, are respectively placed over the external ears of the user. In addition, each ear cup is internally configured with a sound cavity, and a speaker unit disposed in the interior of the sound cavity is used to emit sounds. Sounds from the stereo headphone speaker units resonate within the sound cavity of each headphone to increase the sound quality and volume therein. Sounds emitted by stereo headphone speaker units of the prior art are medium-high frequency pitch sounds of poor resolution, and are sounds which are biased toward medium-low frequencies. And conventional electret electrostatic speakers, such as tower speaker stereo systems, use an electret membrane to produce medium-high frequency sounds, and can blend low-frequency pitch sounds emitted by stereo headphone speaker units. Regarding the medium-low frequency pitch sounds of headset speaker units and medium-high frequency pitch sounds of electret electrostatic speaker units, there are problems related to the speaker units producing second-delay transmission problems of high and low-pitched sounds, resulting in the listener hearing separation between the high and low frequency pitch sounds. This produces serious differences between the medium-high frequencies and the medium-low frequencies, which affects the quality of the sound. Hence, there is an urgent need for improvement.

### SUMMARY OF THE INVENTION

Accordingly, the primary object of the present invention is to use a dual sound channel which blends together medium-high frequency pitch sounds of an electret headphone unit (E-STAT) and medium-low frequency pitch sounds of a moving coil type headphone unit through a frequency divider, which are then respectively supplied to high and low pitch frequency sound speakers for sound output therefrom. Because of the faster transmission speed of medium-high frequencies, the present invention slightly delays transmission of medium-high frequency pitch sounds, and then synchronously transmitted together with medium-low frequency sounds. This prevents the listener from having a sense of separation between the high and low pitch sounds, thus increasing the audio frequency resolution of the headphones.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic view of the present invention.

FIG. 2 shows a schematic view according to a hybrid electrostatic headphone module of the present invention.

FIG. 3 shows another schematic view of the hybrid electrostatic headphone module of the present invention.

FIG. 4 shows a circuit diagram of the present invention.

FIG. 5 shows a schematic view of a frequency division curve of the hybrid electrostatic headphone module.

### DETAILED DESCRIPTION OF THE PREFERRED EMBODIMENTS

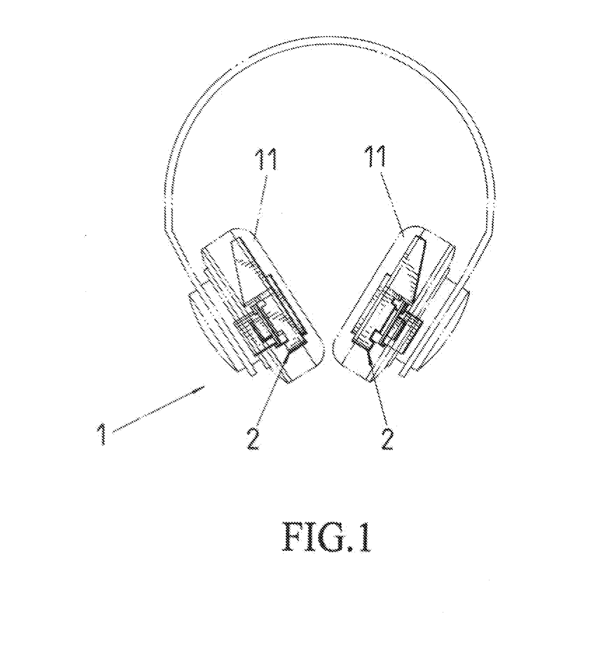

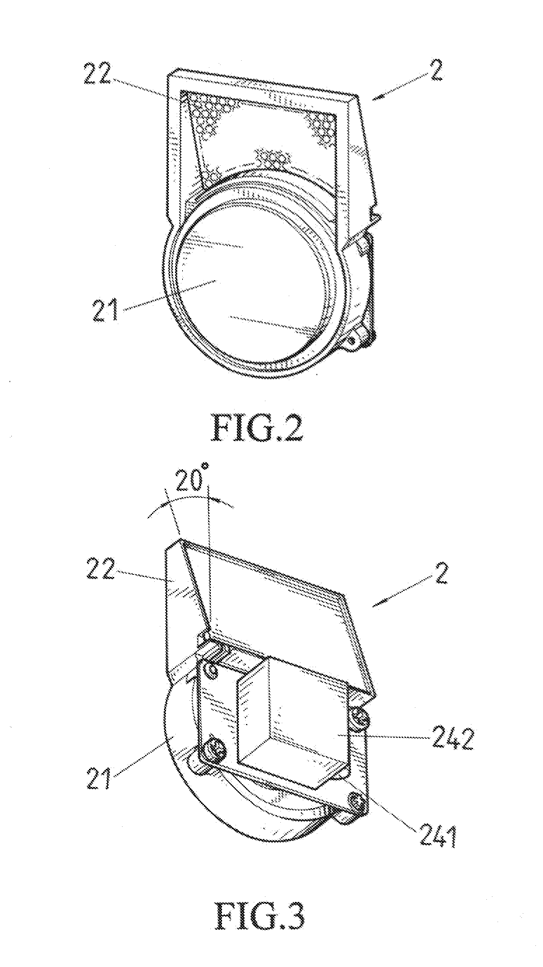

Referring to FIG. 1, a hybrid electrostatic headphone module 2 is respectively disposed in the interior of left and right ear cups 11 of a dual earset stereo headphones 1. Referring to FIGS. 2 and 3, each of the hybrid electrostatic headphone modules 2 comprise a first headphone unit 21 and a second headphone unit 22, wherein the first headphone unit 21 is a conventional moving coil type headphone unit. The first headphone unit 21 is disposed so as to be close to the corresponding left or right external ear of a user, and is responsible for medium-low frequency bands. The second headphone unit 22 is responsible for medium-high frequency bands, and is an electret headphone unit (E-STAT). The characteristic ultra-high pitch technology adopted by E-STAT is a type of technology known as “SBESUD.” SBESUD is the abbreviation for Self-Biasing Electrostatic Unit Driver, which is a high polymer electret and a type of dielectric material having a similar permanent charge thereto. The effective surface area of the interior of the material can be significantly increased through a hole formation manufacturing process, thereby improving the electret charge density on the surface of the material. Such material is able to store a charge for a long period of time, and when applied in an headphone 40 mm* 30 mm (millimeters) electrostatic unit, the frequency response can reach 5 KHz˜40 KHz (kilohertz), with an efficiency of more than 90 dB (decibels), and a 5 KHz˜40 KHz average sound pressure of more than 92 dB. Moreover, the maximum sound pressure can reach up to 115 dB.

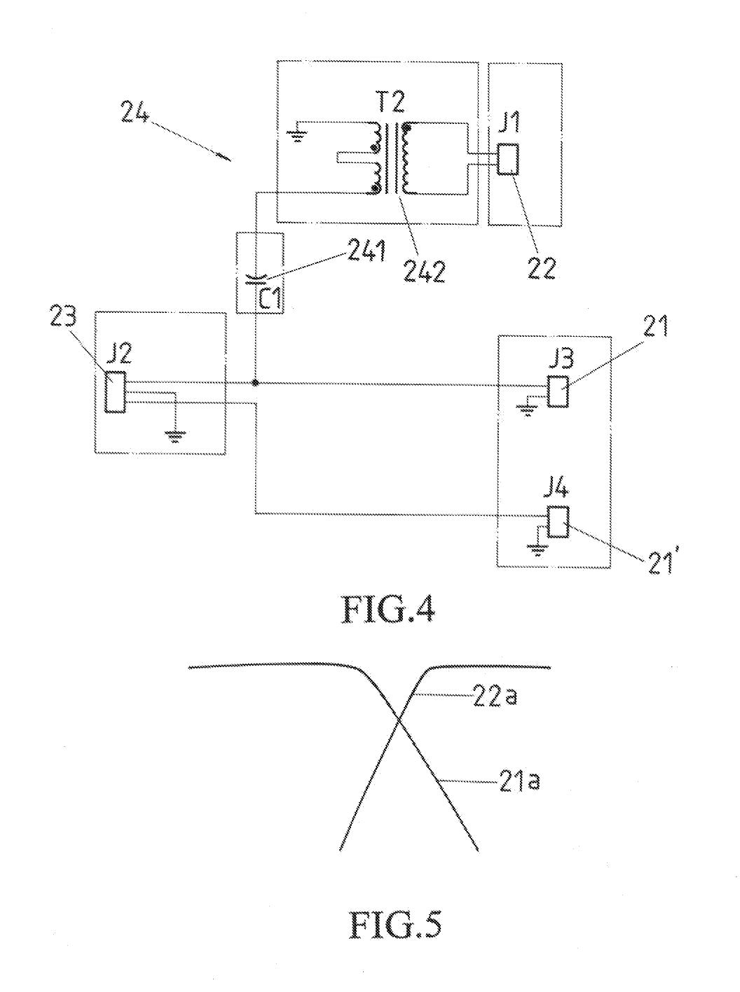

Referring to FIG. 4, when the hybrid electrostatic headphone module 2 is operating, a sound source input module 23 is used to vibrate and produce sound, which is then transmitted directly to the first headphone units 21, 21′ inside the left and right ear cups 11 respectively, and the sound output therefrom. Wherein the first headphone unit 21 inside the left ear cup 11 achieves a frequency division effect through use of an internal frequency divider 24. The frequency divider 24 is assembled from a frequency dividing capacitor 241 and a drive transformer 242. For example, when a frequency band is increased in excess of 5 KHz˜20 KHz (ALT), word recognition is masked out. The frequency divider 24 divides a complete signal into two bands of high and low frequencies, which are then respectively supplied to high and low frequency sound speakers to complete the operation, and then further transmitted to the second headphone unit 22 inside the left ear cup 11 for output therefrom. FIG. 5 shows a crossover region of frequency band signals 21a, 22a emitted by high and low frequency sound speakers of the moving coil type first headphone unit 21 and the E-STAT second headphone unit 22 respectively. For the frequency band signals in this region, both the high and low frequency sound speakers will react simultaneously. By delaying the medium-high frequency sounds, and then blending them together with the medium-low frequency sounds, the listener will not have a sense of division between the high and low frequency sounds. With the high and low frequency sounds being output from different units, the deep low frequency sounds and rich, clear medium-high frequency sounds are retained. Apart from preserving reproduction of the original sounds of the music, the present invention further possesses outstanding audio frequency resolution. In rendering various sound stages, regardless of sense of surround sound or sense of layering, the present invention greatly stands out compared to the performance of traditional moving coil type headphone single units.

Referring to FIG. 3, design of the dual sound hybrid electrostatic headphone module 2 is directed toward improving the asynchronous problems between medium-high frequency sounds and medium-low frequency sounds resulting from the speed of high frequency sounds being faster than the speed of low frequency sounds. The relative offset correction design of the second headphone unit 22, whereby the second headphone unit 22 is inclined at an angle of 20 degrees, enables high, medium, and low frequency bands to be simultaneously accurately transmitted to the interior of the external ears of a listener.

In conclusion, according to the above description of the embodiments, the present invention adopts a dual sound channel in the interior of stereo headphones, and uses an internal frequency divider assembled from a frequency division capacitance and a drive transformer to achieve a frequency division effect, thereby enabling high and low frequency sound bands to be respectively output from different modules. Accordingly, the present invention is able to retain reproduction of the original medium, high, and low frequency sounds, and further possesses outstanding audio frequency resolution.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A hybrid electrostatic headphone module, the hybrid electrostatic headphone module is disposed inside a left and a right ear cup of a stereo headphones; the hybrid electrostatic headphone module comprises a first headphone unit and a second headphone unit, the first earphone unit is responsible for medium-low frequency bands, and the second headphone unit is responsible for medium-high-frequency bands; when the hybrid electrostatic headphone modules are operating, a sound source input module is used to vibrate and produce sound, the sound is then respectively transmitted to the first headphone unit and the second earphone unit for output therefrom; the first headphone unit inside one of the ear cups achieves a frequency division effect through use of an internal frequency divider; the frequency divider assembled from a frequency dividing capacitor and a drive transformer divides a complete signal into two bands of high and low frequencies, which are respectively supplied to high and low frequency sound speakers to complete the operation, and then further transmitted to the second headphone unit for output therefrom.

2. The hybrid electrostatic headphone module according to claim 1, wherein the first headphone unit is a general moving coil type headphone unit, and the second headphone unit is an electret headphone unit (E-STAT).

3. The hybrid electrostatic headphone module according to claim 1, wherein the second headphone unit has a relative offset correction design and configured at an inclined angle of 20 degrees.
